(19) United States
(12) Patent Application Publication
(10) Pub. No.: US 2008/0091936 A1
(43) Pub. Date: Apr. 17, 2008

(54) COMMUNICATION APPARATUS, CONTROL METHOD FOR COMMUNICATION APPARATUS AND COMPUTER-READABLE STORAGE MEDIUM

(76) Inventor: Hiroaki IKKANZAKA, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/869,392

(22) Filed: Oct. 9, 2007

(30) Foreign Application Priority Data
Oct. 11, 2006 (JP) 2006-27802

(51) Int. Cl. H04L 9/00

(52) U.S. Cl. 713/150

(57) ABSTRACT

A communication apparatus including: a storage unit configured to store a plurality of address data for outputting a document data, a control unit configured to relate at least one of a cipher information to encrypt the document data and a certification information for a transmitter of the document data to each address data stored in the storage unit, an encryption unit configured to encrypt the document data based on the cipher information related with the each address data, a certification unit configured to certify the document data based on the certification information related with the each address data, and an output unit configured to output at least one of an encrypted document data by the encryption unit and a certified document data by the certification unit to a network.

### BACKGROUND OF THE INVENTION

1. Field of the Invention

The present invention relates to a communication apparatus, control method for communication apparatus and computer-readable storage medium.

2. Description of the Related Art

In many enterprises, there has been an increase in the amount of devices connectable to a network, such as a multi-function peripheral that is configured to send e-mails (e.g., Internet facsimile device or a network scanner), because of the rapid spread of the Internet. For example, the Internet facsimile device can send and receive e-mails with various kinds of files such as an image file, or a text file. Since the Internet facsimile device sends and receives e-mails with the files over LAN or Internet, they can do that much faster than the previous facsimile devices using G2 or G3 facsimile protocol over PSTN. Generally, the Internet facsimile device may communicate over PSTN and communicate over a network.

When a receiving facsimile device receives a file attached to an e-mail from a sending facsimile device, the receiving facsimile device automatically prints the file or prints the file when it receives an instruction from the user who noticed the reception of the e-mail. However, another user who is not permitted to see the contents of the files attached to the e-mail may see the contents of the files.

An image communication device which restricts an ability to see the contents of each file sent from a sending facsimile device has been previously proposed.

Also, a facsimile device that converts received facsimile data into PDF format and creates a digital signature from the discrimination information of a sending terminal has been previously proposed.

In addition, a facsimile device that can set a way of transmitting an encrypted document has been previously proposed.

According to conventional facsimile devices, it is necessary for the user to set a password for each file or e-mail address, for the user to create a digital signature on each PDF data, and for the user to select the recipient of each encrypted document every time a transmission is made. This is because the user has to complete the above-noted steps every time a document is transmitted, even if the user has previously sent a document to the destination.

### SUMMARY OF THE INVENTION

It is an object of the present invention to provide a communication apparatus to ease the extra efforts required to securely transmit the document data.

Another object of the present invention is to provide a control method for a communication apparatus processed in the communication apparatus described above.

Another object of the present invention is to provide a computer readable storage medium which stores instructions, that executed by a computer, causes the computer to perform as the communication apparatus described above.

### BRIEF DESCRIPTION OF THE DRAWINGS

FIG. 1 is a block diagram showing hardware layout of multi function device as an example of a communication apparatus connected to a personal computer over a network;

FIG. 2 is a block diagram showing a function layout of the multi function device;

FIG. 3 is a perspective view of an operating panel of the multi function device;

FIG. 4 is a schematic illustration of an address editing screen;

FIG. 5 is a schematic illustration of an operation panel showing a transmission configuration screen;

FIG. 6 is a schematic illustration of an operation panel showing a user interface to use when a transmission fails;

FIG. 7 is a schematic illustration of an operation panel showing a user interface when a digital signature is expired;

FIG. 8 is a schematic illustration of an operation panel showing a configuration of destination;

FIG. 9 is a flow chart explaining a performance of communication apparatus; and

FIG. 10 is an illustration of an operating panel showing a user interface for selecting a way to encrypt or sign the document data.

### DESCRIPTION OF THE PREFERRED EMBODIMENTS

A description will be given of embodiments of the communication apparatus, control method for communication apparatus and computer-readable storage medium, by referring to the drawings.

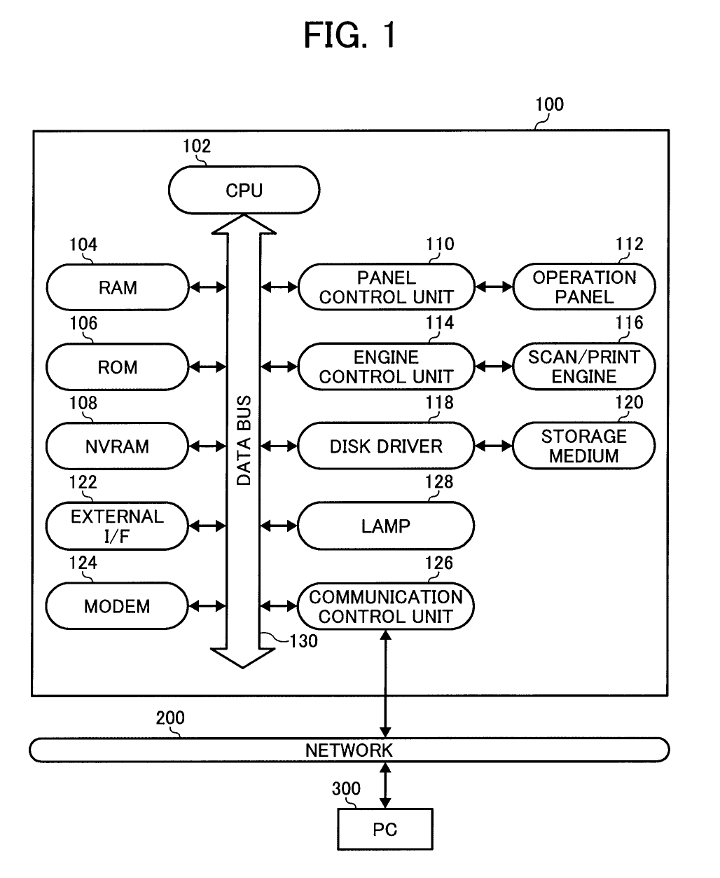

FIG. 1 is a block diagram showing a hardware layout of the MFD (multi function device) 100 as an example of the communication apparatus. In this embodiment, the MFD 100 is a device including a printing function, copying function, facsimile function, scan function, network function, and document data storage function. The MFD 100 is connected to a personal computer over a network.

The MFD 100 has a CPU 102, a RAM 104, a ROM 106, a NVRAM (Non Volatile RAM) 108, a panel control unit 110, an operation panel 112, an engine control unit 114, a scan/print engine 116, a disk driver 118, an external I/F 122, a modem 124, a communication control unit 126, and a lamp 128.

The CPU 102 controls the RAM 104, the ROM 106, the NVRAM 108, the panel control unit 110, the operation panel 112, the engine control unit 114, the scan/print engine 116, the disk driver 118, the external I/F 122, the modem 124, the communication control unit 126, and the lamp 128. They are connected to each other over a data bus 130.

The RAM 104 stores data temporarily. The ROM 106 stores programs, font data, and other static data. NVRAM 108 stores non-volatile data. The panel control unit 110 and the operation panel 112 execute a program for a user interface and the panel control unit 110 controls the operation panel 112 to display various screens to be described below.

The engine control unit 114 and the scan/print engine 116, as an input and output unit, scans a paper document and prints on a recording paper. The disk driver 118 causes a storage medium 120 to store an image data. The external I/F 122 enables the MFD 100 to communicate with other external devices. The modem 124 enables the MFD 100 to connect to PSTN (Public Switched Telephone Network). The communication control unit 126 enables the MFD 100 to connect with Ethernet, LAN (Local Area Network), or Internet, and to communicate with another external device over a network, such as another MFD or PC 300. The lamp 128 notifies the user of an operational state of the MFD 100.

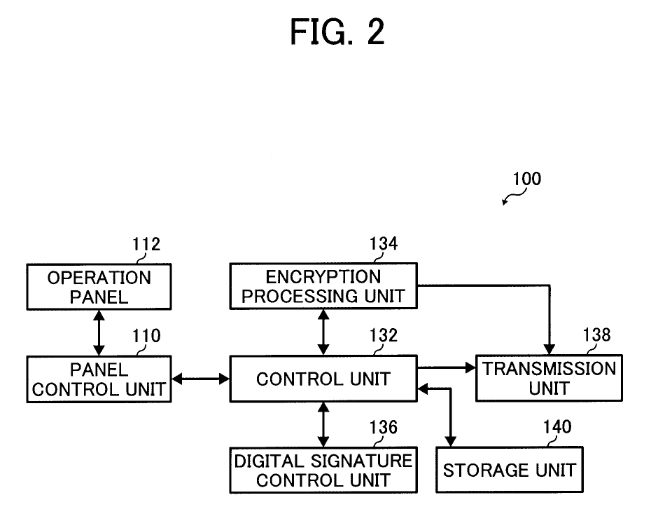

Next, a description will be given of the function of the MFD 100, by referring to FIG. 2.

The MFD 100 has a control unit 132, an encryption processing unit 134, a digital signature control unit 136, a transmission unit 138, and a storage unit 140.

The control unit 132 controls other units to make them perform each of the functions of the MFD 100.

The encryption processing unit 134 encrypts document data to be transmitted to another MFD or PC 300. Possible cipher systems and encryption algorithms that may be applied to the document data to be transmitted include a public key cryptosystem such as S/MIME (Secure Multipurpose Internet Mall Extensions), the symmetric key cryptosystem such as DES (Data Encryption Standard) or 3DES, PGP (Pretty Good Privacy), RSA (Rivest-Shamir-Adleman) method, or IDEA (International Data Encryption Algorithm). A person of ordinary skill in the art will recognize that other cipher systems and encryption algorithms may be used. The document is encrypted by encryption processing unit 134 according to the cipher system selected by the user for each address destination. Different cipher systems may be selected for different address destinations that receive the same document data. Then the control unit 132 controls the panel control unit 110 so that the user can select one of the cipher systems through an encryption/signature selection screen to be described below.

The digital signature control unit 136 creates digital signatures to add onto the document data. In this embodiment, the MFD 100 can send a digital certificate issued from a given CA (Certification Authority) with a digital signature to a receiving MFD. This digital certificate may include information regarding its validity, expiration, and the issuer. In addition, the digital signature control unit 136 may be configured to send the digital certificate issued from the Certification Authority (CA) with a digital signature to a receiving MFD. In this case, the CA confirms the identity of sender. The CA attests that a public key continued in the certificate belongs to the sender. Thus, it will be possible to prove that the document data is not falsified and reconfirm the identity of the sender of the document data. In addition, the digital signature control unit 136 monitors the expiration of the certificate and notifies the user if the certificate is expired.

The digital signature control unit 136 also creates a hash value from the document. The hash value is a compressed value determined by assigning the original data (i.e., the document data) to a hash value of a one way function. Next the digital signature control unit 136 creates a digital signature by encrypting the hash value with the private key that the MFD 100 has. As a result, the digital signature is created from the hash value and included in the document. The digital signature will be sent with the document data. A receiving MFD decrypts the digital signature with the public key of a signatory, the MFD 100, and confirms the validity of the decrypted signature. In detail, the receiving communication apparatus creates a hash value from the received document, compares the hash value with a hash value determined by decrypting the digital signature, and confirms by checking the agreement between the former and latter. Thus, in addition to preventing a third person from falsifying the document data, sending the document data with the digital signature can also prove that the signatory has created the document, and that the document is not falsified.

The transmission unit 138 transmits the document data to the address over a network. In addition, the transmission unit 138 in this embodiment may both transmit the document data through the computer like a mail server and transmit the document data to a selected address directly. The transmission unit 138 can send the following document data for example; a plain document, an encrypted document, a plain document combined with a digital signature, and an encrypted document combined with the digital signature. In addition, with regard to sending the document data combined with the digital signature, it may be possible to send them with the certificate described above.

The storage unit 140 stores setting information regarding how to transmit the document data input into the MFD 100. The setting information includes information indicating whether to encrypt/sign the document data, information indicating how to process the document if transmission fails, and/or how to encrypt the document data, for example. The document data, for example, can be an image data scanned by the scan/print engine 116 or an application data received from PC 300. The document data may be stored in the storage device for each job.

In addition, the storage unit 140 stores a plurality of address data to be used when transmitting the document data, such as an e-mail address. The NVRAM 108 or the storage medium 120 performs as the storage unit 140.

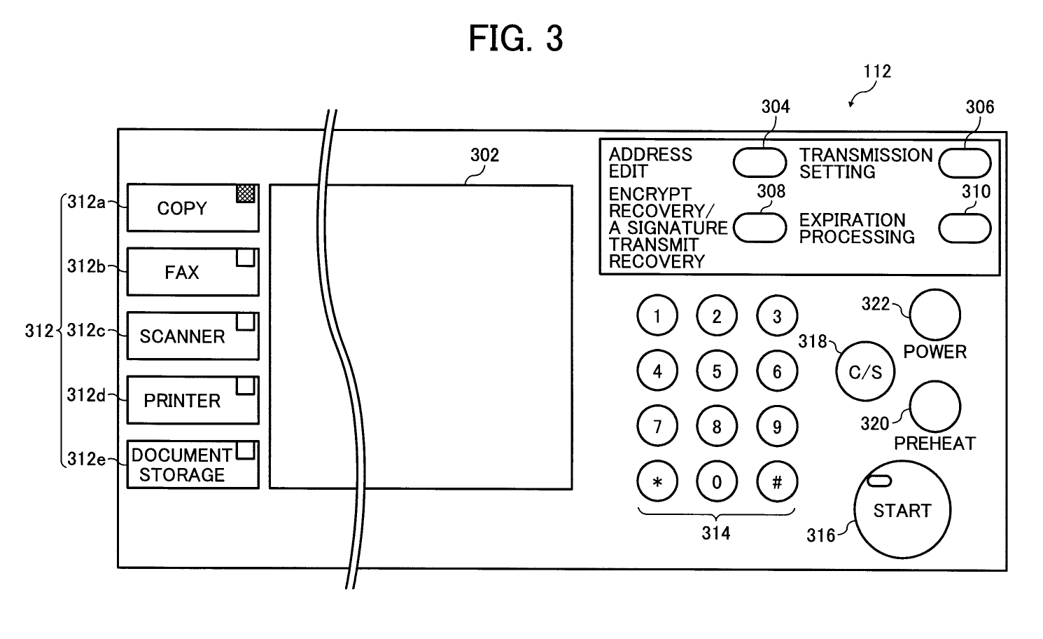

Next, the detailed description of the operation panel 112 will be given. As shown in FIG. 3, the operation panel 112 includes a touch panel 302, an address edit button 304, a transmit setting button 306, an encrypt recovery/a signature transmit recovery button 308, an expiration processing of a digital certification button 310, application key 312, ten key 314, a start key 316, a clear/stop key 318, a preheat key 320, and a power key 322.

The touch panel 302 includes a liquid crystal panel and displays a destination address and the operation setting such as copying conditions, scanning conditions, facsimile conditions, or printing conditions, for example. Then the user can operate the MFD 100 by touching a button displayed on the panel.

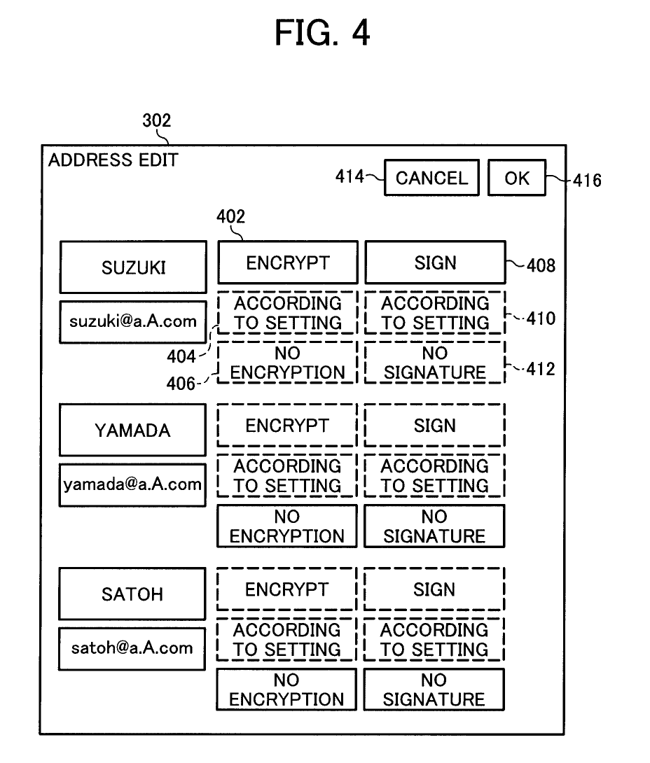

The address edit button 304 is used to call an address editing screen, as shown in FIG. 4, in the touch panel 302. The detail of the address editing screen will be described below.

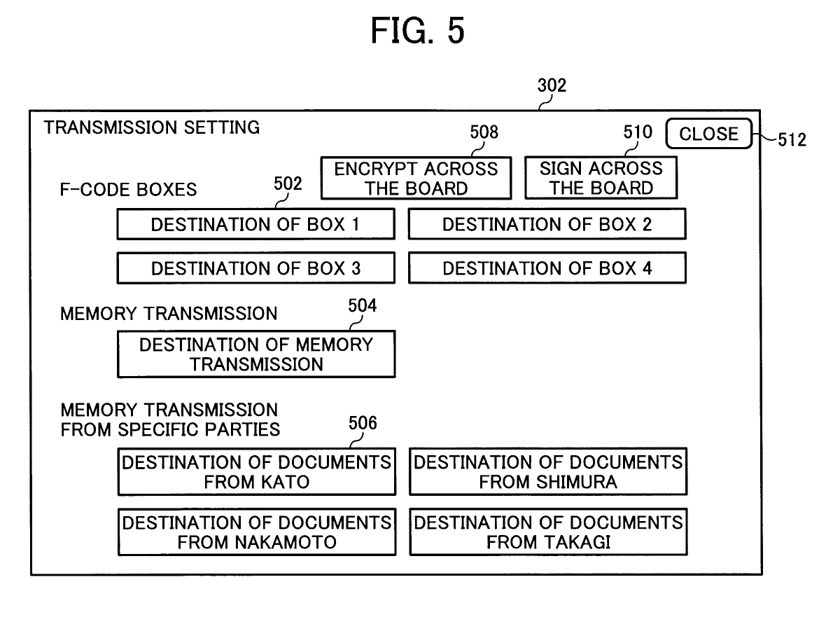

The transmit setting button 306 is used to call a transmission setting screen, as shown in FIG. 5, in the touch panel 302. The detail of the transmission setting screen will be described below.

The encrypt recovery/signature transmit recovery button 308 is used to call an encryption recovery/signature transmission recovery screen in the touch panel 302. The detail of this screen will be described below.

The expiration processing key 310 is used to call an expiration processing screen on the touch panel 302. The detail of the expiration processing screen will be described below.

The application keys 312 are used to select a function of the MFD 100. The application keys 312 include copy key 312a, FAX key 312b, scanner key 312c, printer key 312d, and document storage key 312e. Ten key 314 is used to set a number of copies or prints. In addition, it can be used as a shortcut key and a speed dial key. The start key 316 is used to start jobs of the MFD 100 which include starting to copy, print, scan, and so on. The clear/stop key 318 is used to clear a job settings or stop a job of MFD 100. The preheat key 320 is used to switch the MFD 100 from regular mode into preheat mode. The power key 322 is used to turn on/off the MFD 100.

Next, the description of FIG. 4 will be given. FIG. 4 is an example of the address editing screen displayed in the touch panel 302 by selecting the button 304. In this screen, buttons are used to set an encryption setting or certification setting for each address. More specifically, the button on the address editing screen includes a button 402 to encrypt the document data, a button 404 to encrypt the document data according to a method selected by a user, a button 406 not to encrypt the document data, a button 408 to add a digital signature to the document data, a button 410 to add the digital signature according to a method selected by a user, a button 412 not to add the digital signature to the document data, a close button 414 to close the screen, and an OK button 416 to store the selections made during the address editing.

Moreover, the address data includes an address name and an e-mail address, which are displayed in this screen. For example “SUZUKI” is displayed as the address name and “suzuki@a.com” is displayed as the e-mail address. Thus, the address data and the buttons which are used to select an encryption setting or certifying digital signature setting are displayed in correspondence to each other.

The details of the internal process of the MFD 100 will be provided to the control unit 132 when button 402 is selected, for example. If the button 402 with regard to the address data “SUZUKI” is selected in the touch panel 302, a setting instruction for encrypting the document data is input to the control unit 132 through the panel control unit 110. Based on this instruction, the control unit 132 controls the storage unit 140 to store the setting instruction for the document data and the digital signature. The storage unit 140 stores the setting instruction corresponding to the address data. In this case, the setting instruction of encrypting the document data is stored in the storage unit 140 related with the address data “SUZUKI”. With regard to other address data, it is possible to store the setting instruction in the same manner.

Moreover, if the application key, for example the FAX key 312b, is entered and the instruction of transmission to a given address is input in the control unit 132, the control unit 132 controls the storage unit 140 and reads the setting instruction related with the given address. The control unit 132 inputs the setting instruction read out of the storage unit 140 to the encryption processing unit 134. The encryption processing unit 134 encrypt the document data and output the encrypted data to the transmission unit 138 and the transmission unit 138 transmits the encrypted document data to the address.

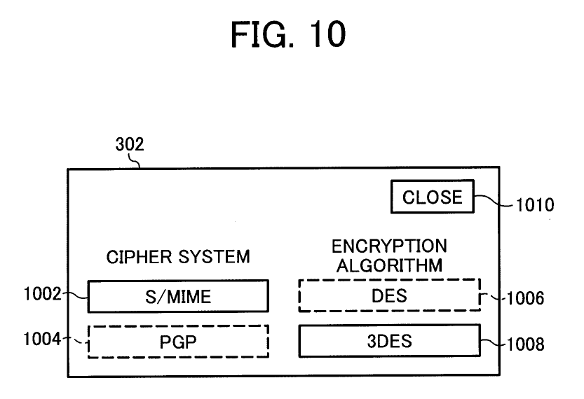

It may be possible to select the way of encrypting or signing a signature in the screen as shown in FIG. 10 in case one of buttons 402, 404, 408, and 410 is selected, for example.

In FIG. 10 there are buttons corresponding to a cipher system and encryption algorithm, which include a button 1002 to use S/MIME, a button 1004 to use PGP, a button 1006 to use DES, and a button 1008 to use 3DES. Further, in this screen, S/MIME is selected as the cipher system, and 3DES is selected as the encryption algorithm. The cipher system refers to an encryption protocol that applies cryptographic methods. The encryption protocol describes how the encryption algorithms should be used. The encryption algorithm is the method of generating the keys. Different encryption algorithms have different key strength, wherein different strengths may be better suited for different document data.

Herewith, the user can set the cipher system and encryption algorithm easily in this screen.

Next, the description of FIG. 5 will be given. FIG. 5 is an example of the transmission editing screen displayed in the touch panel 302 by selecting the button 306. In this screen, a plurality of buttons regarding the transmission setting. More specifically, a button 502 is used to set the destination to transmit the document data using F-code, a button 504 is used to set the destination for a memory transmission, a button 506 is used to set the destination to transmit document data from a specific transmitter, a button 508 is used to encrypt all the document data across the board, a button 510 is used to add the digital signature on the document data across the board, and a button 512 is used to close this screen.

Memory transmission is a method of data transmission that stores the document data in memory, and then transmits it to the destination address.

The F-code is a code number to identify each of confidential boxes (i.e., F-code box 502) created for the confidential communication using a function of storing image data in the MFD 100. Since the F-code is designated to each confidential box and a group of address destinations are registered in each confidential box in advance, the MFD 100 can send the document data to the group of address destinations according to a selection of the F-code. In addition, a box name and a password can be set in each of confidential boxes. The MFD 100 sends a signal to another MFD to indicate the confidential communication in the pre-transmission sequence and to indicate an F-code registered in the confidential box of a confidential address if the transmitter wants to communicate confidentially.

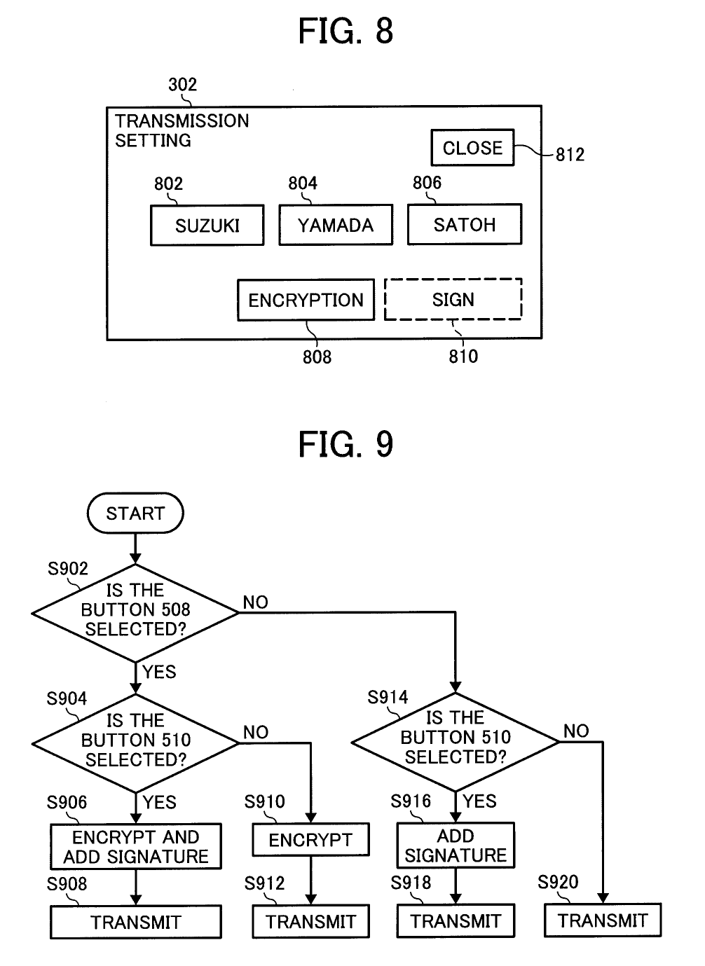

Meanwhile, if the button 508 or the button 510 is selected, the setting instruction for encrypting the document data across-the-board or for signing the document data across-the-board is input to the control unit 132 through the panel control unit 110 and the control unit 132 stores the setting instruction to the storage unit 140. By the selection of button 508 or 510, a document data sent to the plurality of addresses in the box is encrypted or signed for the transmission to each of the addresses in the box. In this case, the control unit 132 applies these setting instructions to the MFD 100, so the document data transmitted from the MFD 100 is encrypted or signed across-the-board. The detail of the transmission setting will be given in the case where button 504 is selected, for example. If the button 504 is selected, a detailed transmission setting screen as shown in FIG. 8 is displayed. In this screen, address name buttons 802 to 806 indicate each address name, a button 808 is used to select the encryption setting, a button 810 is used to select the signature setting, and a close button 812 is used to close this screen and return to the screen shown in FIG. 5. In this case, the address name “SUZUKI”, “YAMADA”, and “SATOH” are selected as the destination of memory transmission and the encryption setting is applied to the document data to be transmitted to each destination. But the signature setting is not applied because the button 810 is displayed with broken line, which indicates that it is not selected.

The user can change the transmission setting by selecting the address name button 802 to 806, the encryption button 808, and the signature button 810. An instruction for the selected settings is input to the control unit 132 through the panel control unit 110, and the control unit 132 controls the storage unit 140 to store the setting. As a result of the control by the control unit 132, the transmission setting according to the destination is stored in the storage unit 140. With regard to the other transmission setting as shown in FIG. 5, it is possible to set the transmission setting in the same manner described above.

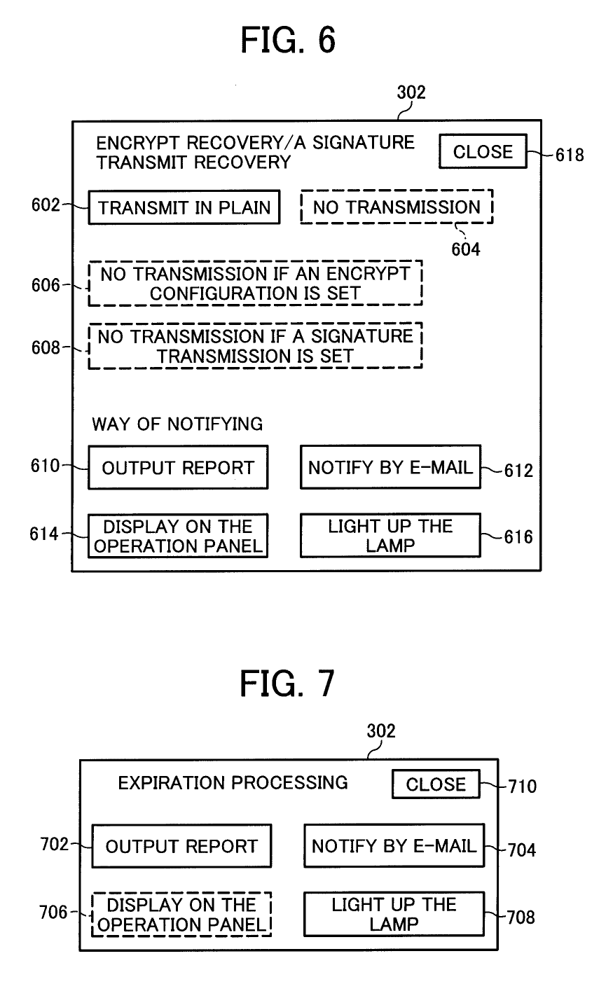

Next, the description of FIG. 6 will be given. FIG. 6 is an example of the recovery setting screen displayed in the touch panel 302 when button 308 is selected. In this screen, a plurality of buttons are displayed and the MFD 100 conducts the recovering processing based on the settings made in this screen. Recovery processing is used if the MFD 100 failed to transmit the document data.

More particularly, a button 602 is used to transmit the document in plain (i.e., without encryption or signature), a button 604 is used not to transmit the document again, a button 606 is used not to transmit the document data if an encryption configuration is set, and a button 608 is used not to transmit the document data if a signature transmission is set. If the signature transmission is set, then it includes a command to add the digital signature to the document data.

In this screen, the setting “transmit in plain” of the button 602, illustrated with a full line, is selected in the MFD 100. If the user selected the button 602, the instruction of the setting corresponding to the button 602 is input to the control unit 132 through the panel control unit 110 and the instruction is stored in the storage unit 140.

In addition, if the MFD 100 fails to transmit the document data it is possible to select a way of notifying the user of the failure. Buttons 610 to 616 indicate the way of notifying the user of the failure. More particularly, a button 610 is used to select output report, a button 612 is used to select notify by e-mail, a button 614 is used to select display on the operation panel, a button 616 is used to select light up the lamp, and a button 618 is used to close the screen. The internal process of setting is conducted in the same manner as described above.

Now, the internal processing based on this recovery setting as shown in FIG. 6 will be explained. If the transmission of the document data failed, the control unit 132 controls the storage unit 140 to read the recovery setting and obtain the recovery setting read out of the storage unit 140. Then the control unit 132 refers to the recovery setting and controls the transmission unit 138 to transmit the document data in accordance with the recovery setting. As a result, the transmission unit 138 transmits the document data in plain (i.e., without encryption or signature). The recovery setting data may be set for each address data, individually, in the storage unit 140.

Next, the description of FIG. 7 will be given. FIG. 7 is an example of a screen to set an expiration processing and this screen is displayed in the touch panel 302 when the button 310 is selected. The buttons included in the expiration processing screen include a button 702 used to select output report, a button 704 used to select notify by e-mail, a button 706 used to select display on the operation panel, a button 708 used to select light up the lamp, and a button 710 used to close the setting screen. If the setting of digital signature transmission indicates that the digital signature is to be attached to the document data and the signature is expired (i.e., digital signature is no longer valid), the MFD 100 performs according to the expiration processing setting.

In this screen, the “display on the operation panel” of the button 706 illustrated with broken line is set in the MFD 100. If the user selected the button 706, the instruction of the setting corresponding to the button 706 is input to the control unit 132 through the panel control unit 110 and the instruction is stored in the storage unit 140. Thus, the MFD 100 performs according to the expiration processing setting. With regard to the other transmission setting as shown in FIG. 7, it is possible to set the transmission setting in the same manner described above.

Next, the description of FIG. 9 will be given in a case of transmitting the document data. In this flow diagram, the transmission setting screen as shown in FIG. 5 is displayed in the touch panel 302.

In this case, at step S902, the control unit 132 confirms whether the button 508 is selected or not. If the control unit 132 detects the selection of the button 508, the process proceeds to step S904. Otherwise, the process proceeds to step S914.

At step S904, the control unit 132 confirms whether the button 510 is selected or not. If the control unit 132 detects the selection of the button 510, the process proceeds to step S906. Otherwise, the process proceeds to step S910.

At step 906, the control unit 132 controls the encryption processing unit 134 and the digital signature control unit 136 to encrypt and add the digital signature to the document data. Then the process proceeds to step S908, and the transmission unit 138 transmits the encrypted and signed document data.

If the control unit 132 doesn't detect the selection of the button 510, the control unit controls the encryption processing unit 134 to encrypt the document data (step S910) and the process proceeds to step S912.

At step S910, the encryption processing unit 134 encrypts the document data and outputs the encrypted document data to the transmission unit 138. As a result, the transmission unit 140 transmits the encrypted document data at step S912.

On the other hand, if the user does not select the button 508, the process goes to step S914. At step S914, the control unit 132 confirms whether the button 508 is selected or not. If the control unit 132 detects the selection of the button 510, the process proceeds to step S916.

At step S916, the control unit 132 controls the digital signature control unit 136 to add the digital signature on the document data. Then the signed document data is output to the transmission unit 138 and the transmission unit 138 transmits the signed document data.

On the other hand, if the control unit 132 does not detect the button 510, the process goes to step S920, and the transmission unit transmits the document data without encrypting and adding the digital signature.

A computer readable storage medium according to the present invention stores the computer readable program described above. Any recording media capable of storing the computer readable program in a computer readable manner may form a computer readable storage medium.

The computer readable program may be prestored in a storage part or means within the computer, such as the ROM and the HDD. On the other hand, the computer readable program may be stored in a non-volatile recording medium or memory, such as a CD-ROM, flexible disk, a SRAM, an EEPROM, a memory card, a magnetic recording medium, an optical recording medium and a magneto-optical recording medium. The computer-readable program stored in the non-volatile recording medium or memory may be installed into the computer and executed by the CPU or, the CPU may read the computer-readable program from the non-volatile recording medium or memory and execute the computer-readable program, so as to realize the functions of any of the embodiments and modifications described above.

Of course, the computer-readable program may be executed by downloading the computer-readable program from an external equipment that is provided with a recording medium recorded with the computer-readable program or, from an external equipment having a storage part or means stored with the computer-readable program.

This application claims the benefit of a Japanese Patent Application No. 2006-278082 filed Oct. 11, 2006, in the Japanese Patent Office, the disclosure of which is hereby incorporated by reference.

Further, the present invention is not limited to these embodiments, but various variations and modifications may be made without departing from the scope of the present invention.

What is claimed is:

1. A communication apparatus comprising:
a storage unit configured to store a plurality of address data for outputting a document data;
a control unit configured to relate at least one of a cipher information to encrypt the document data and a certification information for a transmitter of the document data to each address data stored in the storage unit;
an encryption unit configured to encrypt the document data based on the cipher information related with the each address data; a certification unit configured to certify the document data based on the certification information related with the each address data; and
an output unit configured to output at least one of an encrypted document data by the encryption unit and a certified document data by the certification unit to a network.

2. The communication apparatus as claimed in claim 1, further comprising an operating unit configured to receive at least one of the cipher information and certification information for the communication apparatus.

3. The communication apparatus as claimed in claim 2, wherein the control unit is further configured to send notification of a failure to each address data in the storage unit if the output unit fails to output the at least one encrypted document data and certificated document data.

4. The communication apparatus as claimed in claim 3, wherein the control unit is further configured to relate a setting instruction about processing the document data in case of expiration of the certification corresponding to each address data in the storage unit.

5. The communication apparatus as claimed in claim 4, wherein the setting instruction further includes one of a first setting for encrypting the document data, a second setting for encrypting the document data according to an instruction by an operator of the communication apparatus, and a third setting not to encrypt the document data,
wherein the operating unit is further configured to receive at least one of the setting instructions.

6. The communication apparatus as claimed in claim 5, wherein the setting instruction further includes one of a first setting for certifying transmitter of the document data, a second setting for certifying the transmitter of the document data according to an instruction by an operator of the communication apparatus, and a third setting not to certify of the transmitter of the document data,
wherein the operating unit is further configured to receive at least one of the setting instructions.

7. The communication apparatus as claimed in claim 5, wherein the operating unit is further configured to receive an instruction of a desired cipher system and desired encryption algorithm when one of the first setting and the second setting is received by the operating unit.

8. A communication apparatus comprising:
a storage means for storing a plurality of address data for outputting a document data;
a control means for relating at least one of a cipher information to encrypt the document data and a certification information for a transmitter of the document data to each address data stored in the storage means;
an encryption means for encrypting the document data based on the cipher information related with the each address data;
a certification means for certifying the document data based on the certification information related with the each address data; and
an output means for outputting at least one of an encrypted document data by the encryption means and a certified document data by the certification means to a network.

9. The communication apparatus as claimed in claim 8, further comprising a operating means for receiving at least one of the cipher information and certification information for the communication apparatus.

10. The communication apparatus as claimed in claim 9, wherein the control means sends notification of a failure to each address data in the storage medium if the output means fails to output the at least one encrypted document data and certificated document data to send notification of a failure to each address data in the storage means.

11. The communication apparatus as claimed in claim 10, wherein the control means relates a setting instruction about processing the document data in case of expiration of the certification corresponding to each address data in the storage means.

12. The communication apparatus as claimed in claim 10, wherein the setting instruction further includes one of a first setting for encrypting the document data, a second setting for encrypting the document data according to an instruction by an operator of the communication apparatus, and a third setting not to encrypt the document data,
wherein the operating means further receives at least one of the setting instructions.

13. The communication apparatus as claimed in claim 12, wherein the setting instruction further includes one of a first setting for certifying transmitter of the document data, a second setting for certifying the transmitter of the document data according to an instruction by an operator of the communication apparatus, and a third setting not to certify of the transmitter of the document data,
wherein the operating means receives at least one of the setting instructions.

14. The communication apparatus as claimed in claim 12, wherein the operating means receives an instruction of a desired cipher system and desired encryption algorithm when one of the first setting and the second setting is received by the operating means.

15. A control method for a communication apparatus comprising the steps of:
storing a plurality of address data for outputting a document data in a storage device;
relating at least one of a cipher information to encrypt the document data and a certification information for a transmitter of the document data to each address data in the storage device;
encrypting the document data based on the cipher information related to the each address data;
certifying the document data based on the certification information related to each address data; and
outputting at least one of an encrypted document data by the cipher information and a certified document data by the certification information to a network.

16. A computer readable storage medium which stores a program for causing a computer to perform a process, the process comprising:
storing a plurality of address data for outputting a document data in a storage device;
relating at least one of a cipher information to encrypt the document data and a certification information for a transmitter of the document data to each address data in the storage device; encrypting the document data based on the cipher information related to each address data;
certifying the document data based on the certification information related to each address data;
outputting at least one of an encrypted document data by the cipher information and a certified document data by the certification information to a network.
